(19) United States
(12) Patent Application Publication
(10) Pub. No.: US 2009/0214711 A1
(43) Pub. Date: Aug. 27, 2009

(54) DRINKING WATER FORMULATION AND METHOD AND ARTICLE RELATING TO SAME

(75) Inventor: RAMIN STEPHAN BAYANI, Atlanta, GA (US)

Correspondence Address: INTELLECTUAL PROPERTY / TECHNOLOGY LAW, PO BOX 14329, RESEARCH TRIANGLE PARK, NC, 27709, US

(73) Assignee: ESSENTIALIFE HOMEOPATHICS, Atlanta, GA (US)

(21) Appl. No.: 12/392,382

(22) Filed: Feb. 25, 2009

Related U.S. Application Data
(60) Provisional application No. 61/031,095, filed on Feb. 25, 2008.

(51) Int. Cl. A23L 2/52

(52) U.S. Cl. 426/66

(57) ABSTRACT

A drinking water formulation, including: (a) water; (b) one or more homeopathic ingredients; and (c) at least one additive composition selected from among: (i) sodium benzoate; (ii) citric acid and potassium benzoate; (iii) citric acid and potassium sorbate; and (iv) effervescence agent(s). Potentization methods for manufacturing such formulations are also described. The drinking water formulations may be readily manufactured and bottled in beverage containers, e.g., containers in which homeopathic ingredients and/or additives are released to an aqueous medium at a point of consumption of the drinking water.

### CROSS REFERENCE TO RELATED APPLICATION

Priority is hereby claimed under 35 USC 119 of U.S. Provisional Patent Application No. 61/031,095 filed Feb. 25, 2008 in the name Ramin Stephan Bayani for “SPECIALLY FORMULATED DRINKING WATER.” The disclosure of U.S. Provisional Patent Application No. 61/031,095 is hereby incorporated herein by reference in its entirety, for all purposes.

### FIELD OF THE INVENTION

The present invention relates to drinking water formulations containing homeopathic ingredients, and to beverage articles including such drinking water formulations, and to methods for making and using such drinking water formulations and beverage articles.

### DESCRIPTION OF THE RELATED ART

Consumers have been increasingly attracted to specialty waters and water formulations for drinking purposes. Natural spring waters and carbonated waters are ubiquitous, and in recent years a variety of enhanced water beverages have been commercialized. Such water products include formulations containing a variety of flavors and aromatic ingredients.

There is an increasing public awareness of the health benefits of maintaining active hydration through water consumption, and an increased sophistication related to drinking water products.

### SUMMARY OF THE INVENTION

The present invention relates to homeopathic ingredient-containing drinking water formulations, beverage articles containing such formulations, and methods for making and using such formulations.

In one aspect, the invention relates to a drinking water formulation, comprising:

(a) water;
(b) one or more homeopathic ingredients; and
(c) at least one additive composition selected from among:

(i) sodium benzoate;

(ii) citric acid and potassium benzoate;

(iii) citric acid and potassium sorbate; and

(iv) effervescence agent(s).

In another aspect, the invention relates to a beverage article, comprising:

a beverage container; and
a drinking water formulation in said container, comprising:
(a) water;
(b) one or more homeopathic ingredients; and
(c) at least one additive composition selected from among:

(i) sodium benzoate;

(ii) citric acid and potassium benzoate;

(iii) citric acid and potassium sorbate; and

(iv) effervescence agent(s).

A further aspect of the invention relates to a method of making a homeopathic drinking water formulation, comprising:

(a) providing a mother tincture of a homeopathic ingredient;
(b) diluting the mother tincture in an aqueous medium to form a first mixture;
(c) successing the first mixture;
(d) preparing a final mixture from the first mixture, comprising conducting steps (b) and (c) for a number of times n, wherein n is 0 or a whole number integer; and
(e) adding to at least one of the mother tincture, first mixture and final mixture, at least one additive composition selected from among:

(i) sodium benzoate;

(ii) citric acid and potassium benzoate;

(iii) citric acid and potassium sorbate; and

(iv) effervescence agent(s).

Other aspects, features and embodiments of the invention will be more fully apparent from the ensuing disclosure and appended claims.

### BRIEF DESCRIPTION OF THE DRAWINGS

FIG. 1 is a schematic representation of a process of preparing a homeopathic composition of a mother tincture starting material, involving successive dilution and succession steps, to achieve homeopathic potentization of a homeopathic component.

FIG. 2 is a perspective view of a beverage article according to one embodiment of the invention.

FIG. 3 is an enlarged, partially broken-away view, in perspective, of the cap of the FIG. 2 beverage article.

### DETAILED DESCRIPTION OF THE INVENTION, AND PREFERRED EMBODIMENTS THEREOF

The present invention relates to drinking water formulations containing homeopathic ingredients and additional additives, useful in healthful consumption of drinking water and for homeopathic applications for which homeopathic ingredients are effective.

In contrast to homeopathic remedies made by traditional methods, homeopathic ingredients in the formulations of the present invention can be made in an alcohol-free form, to produce drinking water formulations that are usefully bottled in beverage containers to provide packaged water formulations useful for general consumer use.

Homeopathic ingredients have been developed in various disciplines, to provide remedies for maladies and physiological conditions such as fatigue, feminine ailments, undesired hair conditions, excessive or deficient appetite, immunological deficiency, joint and muscle pain, undesired skin conditions, stress, anxiety, and accumulation of toxins in the body.

Homeopathic ingredients have varied natural sources, including plants, minerals, and animal sources.

Set out below is an illustrative listing of physiological conditions and applications, and the homeopathic ingredients that may be useful for same.

Appetite Control: anacardium orientale, calcarea carbonica, chelidonium majus, fucus vesiculosus, graphites naturalis, guarana (paullina sorbilis HPUS), iodium purum, lycopodium clavatum, natrum sulphuricum, pulsatilla nigricans, sulphur iodatum, thyroidinum; 10X.

Fatigue Relief: alfalfa, ambra grisea, aurum metallicum, avena sativa, caladium seguinum, calcarea carbonica, cocculus indicus, gelsemium sempervirens, kali phosphoricum, phosphoricum acidurm, selenium, silicea terra; 10X.

Feminine: agnus castus, aletris farinose, berberis vulgaris, caulophyllum thalictroides, ferrum metallicum, graphites naturalis, helonias dioica, ignatia arnara, lilium tigrinurn, lycopodium clavaturm, natrum muriaticum, onosrmodium virginianum, pulsatilla nigricans, sepia succus; 10X.

Hair Care: adrenalinum, antimonium crudurm, arsenicum album, borax veneta, fluoricum acidurm, graphites naturalis, kali carbonicum, natrum rnuriaticurn, nitricum acidum, phosphoricum acidum, phosphorus, pix liquida, selenium, sepia succus, silicia terra, sulphur iodatum, thuja occidentalis; 10X.

Immune Boost: apis mellifica, borax veneta, cantharis vesicatoria, cinnabaris, echinacea angustifolia, galium aparine, hepar sulphuris calcareum, lachesis muta, mercurius corrosives, nitric acidum, pituitarum posterium, sulphur iodatum, thuja occidentalis, thymus serpyllum; 10X.

Joint and Muscle Pain: argentum nitricum, arnica Montana, arsenicum album, belladonna, bryonia alba, dulcamara, echinacea angustifolia, hepar sulphuris calcareum, influenzinum, lachesis muta, mercurius vivus, phytolacca decandra, pulsatilla nigricans, pyrogenium, rhus toxicodendron, thuja occidentalis; 10X.

Skin Care: antimonium tartaricum, asterias rubens, ferrum metallicum, hepar sulphuris calcareum, kali bromatum, natrum muriaticum, sanguinaria Canadensis, selenium, sepia succus, silicea terra, sulphur iodatum, thuja occidentalis; 10X.

Stress and Anxiety: aconitum napellus, apis mellifica, arnica Montana, arsenicum album, belladonna, bellis perennis, bryonia alba, calendula officinalis, chamomilla, cistus Canadensis, ferrum phosphoricum, histaminum muriaticum, hypericum perforatum, ignatia amara, impatiens glandulifera flos, ornithogalum umbellatum, passiflora incarnate, phosphorus, prunus cerasifera flos, rhus toxicodendron, sulphur iodatum, symphytum officinale, veratrum album; 10X.

Detoxifier: hepar suis (porcine liver organo); 12X. benzoicum acidum, berberis vulgaris, bryonia alba, cantharis vesicatoria, ceanothus americanus, chelidonium majus, china officinalis, chionanthus virginica, dioscorea villosa, dolichos pruriens, iris versicolor, nux vomica, ptelea trifoliate, taraxacum officinale 10X, carduus benedictus, carduus marianus, cynara scolymos, juniperus communis, solidago virgaurea, taraxacum officinale; 3X.

In the foregoing listing of homeopathic ingredients and associated conditions/applications for which such homeopathic agents are utilized, there is indication of the potency of the ingredients that is utilized for treatment of such condition, e.g., 3X, 10X, or 12X.

Homeopathic ingredients are prepared by a process of “potentization,” involving serial dilution and “succussion” (vigorous shaking) in an aqueous medium. The potency of the homeopathic remedy is described by the 2-part number and letter designation. The numeric part of the letter and number designation indicates the number of times the source substance has been homeopathically diluted and succussed. The letter portion of the number and letter designation indicates the dilution rate. For example, in the potency 12X, the source material has been homeopathically diluted and succussed twelve times and the letter “X” represents Roman numeral 10, a dilution rate of 1/10, or, stated alternatively, 1:10 dilution ratio. A dilution rate of 1/10 is very slow, while a dilution rate of 1/50,000, designated LM, is a fast dilution rate.

Homeopathic ingredients are diluted according to a decimal scale, utilizing an aqueous medium. For example, a dilution factor of 1:10 means that one part of the mother tincture starting material is diluted in 9 parts of the aqueous medium. Ten succussions are carried out between each dilution phase.

An illustrative dilution and succussion dilution process may include the following steps:

Step 1: One part of the mother tincture starting material is diluted in 9 parts of aqueous medium;

Step 2: The diluted liquid is then succussed 10 times in its bottle, e.g., by firmly hitting the bottle's base against a firm but resistive surface, or by automated shaking providing an equivalent liquid condition, so that the resulting liquid has a 1X potency the “1” referring to the first stage of dilution and the Roman numeral “X” referring to the 1:10 dilution ratio;

Step 3: One part of the 1X potency material is next diluted in 9 parts of aqueous medium and succussed 10 times to produce a 2X homeopathic material; and

Step 4: The serial potentization process of dilution and succussion is repeated for a number of times that produces a desired potency of the homeopathic ingredient.

In instances in which the aqueous medium is a mixture of alcohol and water, the concentration of alcohol may be on the order of 10-30% of the total weight of the aqueous medium (wt/wt %). Dilution mixing with the aqueous medium and succussion is carried out to achieve any desired potencies, such as 3X, 10X or 12X.

Once the homeopathic ingredient has been prepared, it can be stored in suitable containers until used to manufacture the drinking water formulation.

In the drinking water formulation manufacturing operation, the water to be utilized in the drinking water formulation may be subjected to pre-filtration (mechanical filtration) to remove sediment and particles, softening treatment to remove hardness-causing minerals, and carbon filtration to remove objectionable taste and odor components as well as any organic chemicals that may be present. These steps may be followed by reverse osmosis, e.g., to remove 95%+ of dissolved solids in the liquid after the earlier treatments and then demineralization to remove any residual minerals, bringing the water to zero parts per million (ppm) total dissolved solids. The liquid after such treatment may be subjected to ultraviolet (UV) purification, to ensure that the water remains virtually free of microbes.

The production process may include continuous recirculation and ozone or oxygen injection to control microbial growth, thereby avoiding undesirable byproducts that are otherwise associated with chlorination treatment of the water. Such purification may be carried out to effect a residual oxygen component in the liquid for ensuring freshness in subsequent use. Final bacteria filtration may be carried out before bottling.

Bottling, as used herein, refers to the process of introducing homeopathic drinking water formulations of the invention to suitable containers for subsequent consumer use. The beverage container used for bottling may be a bottle or a can that is sealed subsequent to introduction of the drinking water formulation thereto. For example, the beverage container may be of a size to hold 6, 8, 10, 12, 14, 16 or more ounces of the drinking water formulation.

The drinking water formulation manufacturing operation may be carried out to introduce to purified water one or more homeopathic ingredients, prepared as previously described, to provide a homeopathic drinking water formulation.

The homeopathic ingredient or ingredients may be added at any suitable concentration. Typically, a homeopathic ingredient may be added at a concentration of from about 0.05% to 10% by weight, based on total weight of the drinking water formulation. The drinking water formulation in accordance with the invention contains at least one additive composition selected from among (i) sodium benzoate, (ii) citric acid and potassium benzoate, (iii) citric acid and potassium sorbate, and (iv) effervescence agent(s). The additive composition may include the specific ingredients at any suitable concentration that enables the drinking water formulation to be effective for homeopathic use. Typically, such additive composition ingredients are incorporated in the drinking water formulation at a concentration of from about 0.05% to 4% by weight, based on total weight of the formulation.

It has been found that the use of such additive composition ingredients enables effective homeopathic water formulations to be prepared without the need of alcohol in the aqueous medium that is used for dilution and succussion of the homeopathic ingredient. As a result, alcohol-free water formulations may be made that are effective despite the absence of alcohol in the dilution/succussion aqueous medium.

In an illustrative formulation, the drinking water may contain a homeopathic ingredient in liquid or solid form, in an amount of 0.5 milliliter to each 16 ounces of water in the formulation. Sodium benzoate may be added at a concentration of 0.5 weight percent, based on the total weight of the formulation. Alternatively, in place of sodium benzoate, 0.5% by weight of citric acid and 1% by weight of potassium benzoate may be used, or as a still further alternative, a mixture of 0.5% by weight of citric acid and 1% by weight of potassium sorbate may be employed.

The drinking water formulation of the invention may additionally, or alternatively, contain an effervescence agent or agents, to provide an effervescent water formulation for consumption by a consumer.

The effervescence agent may include any suitable effervescing agent, such as a mixture of acids or acid salts and carbonate ingredients that react to release carbon dioxide in the presence of water. For example, suitable acids and acid salts may include citric acid, tartaric acid, malic acid, or corresponding acid anhydride. Carbonates may include sodium carbonate, potassium carbonate or any other suitable alkali metal carbonate or hydrogen carbonate that is useful in reaction with the acid component to release carbon dioxide in the presence of water.

The respective effervescence ingredients may be in the form of powders or solids that are present with one another in a dry mixture that then is added to the drinking water formulation to produce the effervescent water product.

In one embodiment of the invention, the effervescent agents are sequestered in a portion of the beverage container, such as in a compartment in a cap of the container, and are released by the user when readying the beverage article for consumption, so that the drinking water formulation is rendered effervescent in character.

In like manner, the homeopathic ingredients may be packaged separately from the water in the beverage container to constitute the water formulation at the time of use, by releasing the homeopathic ingredients for mixing with the water and additive components of the formulation.

In a further embodiment, all of the additive ingredients and homeopathic ingredients may be mixed with one another, e.g., in a solid and/or liquid form, with the mixture sequestered from the aqueous component of the drinking water formulation in the container and contacted with the water at the time of use for consumption.

Accordingly, the invention contemplates homeopathic ingredients and/or other formulation ingredients in powdered or dry form or alternatively in liquid form, that are mixed with water at the point of use, by means of an integrated package containing water in a separated volume or compartment of the beverage article from the other ingredients.

The homeopathic water formulations of the invention may be utilized as a hydration medium that additionally is useful in treatment of ailments and conditions for which homeopathic remedies are effective, e.g., stress, fatigue, headaches, heartburn, etc.

The drinking water formulations of the invention may variously comprise, consist or consist essentially of specified ingredients herein disclosed. Other ingredients may be incorporated in such formulations, including vitamins, minerals, dietary additives, nutriceuticals, and any other active or inactive ingredients that are usefully incorporated in the drinking water formulation for ultimate use.

The invention contemplates a beverage article, comprising a beverage container, and a drinking water formulation of the invention in such container. As mentioned, the beverage container may be adapted to release effervescent agents and/or homeopathic ingredients by user action in readying the beverage article for consumption.

The invention contemplates a method of making a homeopathic drinking water formulation, beginning with the provision of a mother tincture of a homeopathic ingredient that is diluted to form a first mixture. The first mixture is succussed. A final mixture is prepared from the first mixture, by carrying out dilution (and subsequent succussion) steps for a number of times n, wherein n is zero (in which case the first mixture is the final mixture) or a whole number integer. In this method, at least one additive composition is added to at least one of the mother tincture, first mixture (when different from the final mixture) and final mixture, with the additive composition being selected from among (i) sodium benzoate, (ii) citric acid and potassium benzoate, (iii) citric acid and potassium sorbate, and (iv) effervescence agent(s). The effervescence agents when present may be added at the time of bottling, or may be released from a separate compartment into the water, to produce effervescing action. In like manner, the other additive composition ingredients may be arranged to be added into the water at the point of use.

The invention further contemplates dry mixtures of the homeopathic ingredients and effervescence agents, as a powder composition that is released into the water of the formulation, and that by effervescent action mixes the water volume to disperse and solublize the homeopathic ingredient(s).

The dilution of mother tincture compositions in the practice of the invention may involve the following designations and dilution rates as set forth in Table 1 below.

TABLE 1

| Designation | Dilution Rate |
|---|---|
| X | 1/10 |
| C | 1/100 |
| M | 1/1000 |
| LM | 1/50,000 |

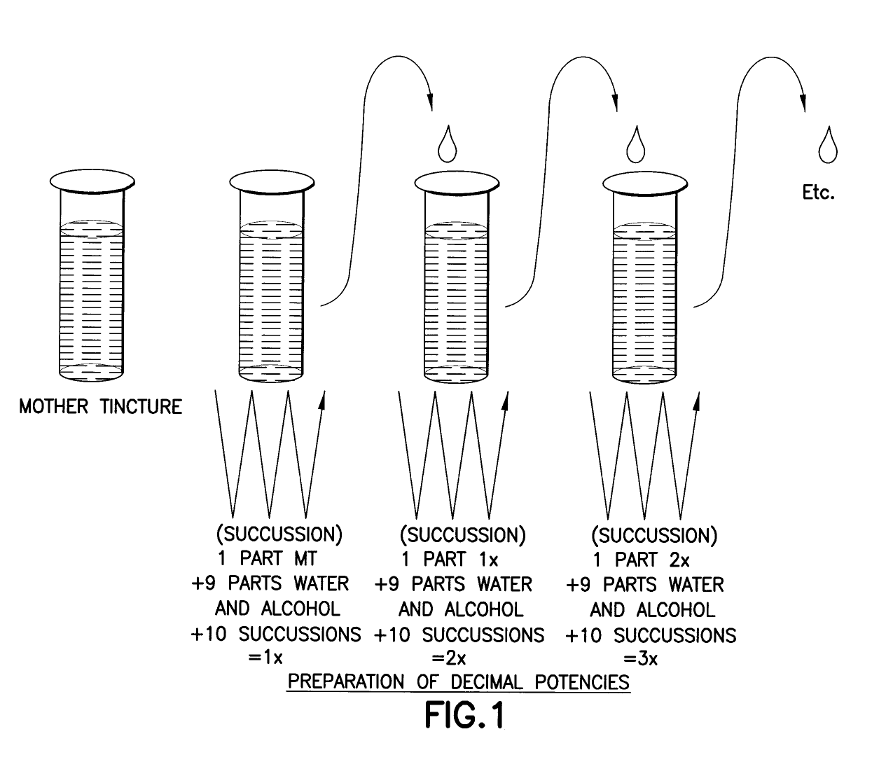

FIG. 1 is a schematic representation of a process of preparing a homeopathic composition of a mother tincture starting material, involving successive dilution and succession steps, to achieve homeopathic potentization of a homeopathic component, with successive steps producing 1X, 2X, and 3X potencies. In this illustrative preparation, the starting material is mixed with an aqueous medium in an amount of 1 part mother tincture to 9 parts water and alcohol mixture. In instances in which non-alcoholic homeopathic water formulations are prepared, the aqueous medium contains no alcohol.

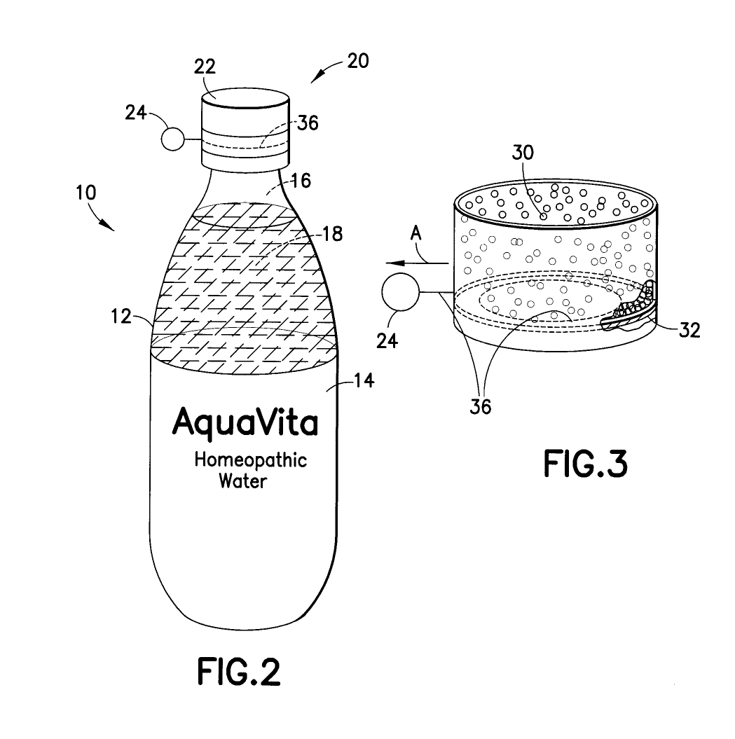

FIG. 2 is a perspective view of a beverage article according to one embodiment of the invention.

The beverage article 10 shown in FIG. 2 includes a beverage container 12 defining an interior volume 16 holding a volume 18 of the homeopathic water formulation. The container may as shown comprise a conventional bottle, or alternatively a can or other container. The container shown includes a sleeve 14 of plastic, cellulosic or other suitable material, containing labeling indicia thereon.

The beverage article 10 includes a cap 20 having suitable threading or other engagement structure for cooperative sealing of the bottle, in a conventional manner.

The cap in this embodiment provides for retention of effervescent agents 30 in a compartment of the cap, as shown in greater detail in FIG. 3, which is a perspective enlarged view of the structure. The cap may include a pull ring 24 as shown, connected to a length of wire 36 that is embedded in a foil barrier element 32 (see FIG. 3). This arrangement maintains the effervescence agents 30 in the compartment of the cap until the point of use, at which time the user pulls the pull ring 24 in the direction shown by arrow A This action causes the wire embedded in the foil barrier element 32 to be withdrawn from the barrier element and the cap, to thereby tear away a circular opening in the barrier element to allow the effervescence agents to gravitationally fall into the underlying liquid 18. The effervescence agents upon contact with such water volume undergo reaction to produce carbon dioxide for carbonation of liquid in the beverage container. The vessel upon subsequent removal of the cap is carbonated in character and ready for consumption.

In like manner, the homeopathic ingredient may be sequestered from the liquid in the cap compartment, and the homeopathic ingredient and additives may then be concurrently mixed into the water to form the homeopathic water formulation.

Caps useful for sequestering the various solid and/or liquid ingredients from the water in the beverage container also include those described in U.S. Pat. Nos. 6,974,024 and 7,070,046 and U.S. Patent Application Publications 2006/0108314, 2007/0119727, 2005/0150902 and 2008/0142473, all in the name of Young Kook Cho.

While the invention has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

What is claimed is:

1. A drinking water formulation, comprising:
(a) water;
(b) one or more homeopathic ingredients; and
(c) at least one additive composition selected from among:
(i) sodium benzoate;
(ii) citric acid and potassium benzoate;
(iii) citric acid and potassium sorbate; and
(iv) effervescence agent(s).

2. The formulation of claim 1, which is non-alcoholic.

3. The formulation of claim 1, wherein said additive comprises sodium benzoate.

4. The formulation of claim 1, wherein said additive comprises citric acid and potassium benzoate.

5. The formulation of claim 1, wherein said additive comprises citric acid and potassium sorbate.

6. The formulation of claim 1, wherein said additive comprises effervescence agent(s).

7. The formulation of claim 1, wherein said additive comprises effervescence agent(s) and one of (i), (ii) and (iii).

8. A beverage article, comprising:
a beverage container; and
a drinking water formulation in said container, comprising:
(a) water;
(b) one or more homeopathic ingredients; and
(c) at least one additive composition selected from among:
(i) sodium benzoate;
(ii) citric acid and potassium benzoate;
(iii) citric acid and potassium sorbate; and
(iv) effervescence agent(s).

9. The beverage article of claim 8, which is non-alcoholic.

10. The beverage article of claim 8, wherein said additive comprises sodium benzoate.

11. The beverage article of claim 8, wherein said additive comprises citric acid and potassium benzoate.

12. The beverage article of claim 8, wherein said additive comprises citric acid and potassium sorbate.

13. The beverage article of claim 8, wherein said additive comprises effervescence agent(s).

14. The beverage article of claim 8, wherein said additive comprises effervescence agent(s) and one of (i), (ii) and (iii).

15. The beverage article of claim 8, wherein said additive comprises effervescence agent(s), and the container is adapted to release the effervescence agent(s) by user action in readying the article for consumption, so that the drinking water formulation is rendered effervescent for such consumption.

16. A method of making a homeopathic drinking water formulation, comprising:
(a) providing a mother tincture of a homeopathic ingredient;
(b) diluting the mother tincture in an aqueous medium to form a first mixture;
(c) successing the first mixture;
(d) preparing a final mixture from the first mixture, comprising conducting steps (b) and (c) for a number of times n, wherein n is 0 or a whole number integer; and
(e) adding to at least one of the mother tincture, first mixture and final mixture, at least one additive composition selected from among:
(i) sodium benzoate;
(ii) citric acid and potassium benzoate;
(iii) citric acid and potassium sorbate; and
(iv) effervescence agent(s).

17. The method of claim 16, wherein said homeopathic drinking water formulation is non-alcoholic.

18. The method of claim 16, further comprising bottling the homeopathic drinking water formulation in a beverage container.

19. The method of claim 18, wherein the homeopathic drinking water formulation includes effervescence agent(s) that are added at the time of bottling.

20. The method of claim 18, wherein the bottled homeopathic drinking water formulation includes effervescence agent(s) that are released by user action in readying the beverage container for consumption, so that the homeopathic drinking water formulation is rendered effervescent for such consumption.
